(19) United States
(12) Patent Application Publication
(10) Pub. No.: US 2009/0285457 A1
(43) Pub. Date: Nov. 19, 2009

(54) Detection of Organ Area Corresponding to Facial Organ Image in Image

(75) Inventor: Kenji Matsuzaka, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/464,692

(22) Filed: May 12, 2009

(30) Foreign Application Priority Data
May 15, 2008 (JP) 2008-127842

(51) Int. Cl. G06K 9/00

(52) U.S. Cl. 382/118

(57) ABSTRACT

An image processing apparatus. A face area detecting unit detects a face area corresponding to a face image in a target image. A detection condition setting unit sets a detection condition for specifying a range of at least one of the number, sizes and positions of organ areas to be detected upon detection of the organ area corresponding to a facial organ image in the face area on the basis of a detection result of the face area. An organ area detecting unit detects the organ area satisfying the set detection condition.

### CROSS-REFERENCE TO RELATED APPLICATIONS

This application claims the benefit of priority under 35 USC 119 of Japanese application no. 2008-127842, filed on May 15, 2008, which is incorporated herein by reference.

### BACKGROUND

1. Technical Field

The present invention relates to detection of an image area corresponding to a facial organ image in an image.

2. Related Art

Techniques are known for detecting an organ area, which is an image area corresponding to an image of a facial organ (such as an eye), in an image. See, for example, JP-A-2006-065640.

It is preferable to improve the accuracy or increase the efficiency of the process of detecting the organ area from the image.

### SUMMARY

The invention provides a technique that improves the accuracy and increases the efficiency of a process of detecting an organ area in an image.

An image processing apparatus according to an aspect of the invention includes: a face area detecting unit that detects a face area corresponding to a face image in a target image; a detection condition setting unit that sets a detection condition for specifying a range of at least one of the number, sizes and positions of organ areas to be detected upon detection of an organ area corresponding to a facial organ image in the face area on the basis of a detection result of the face area; and an organ area detecting unit that detects the organ area satisfying the set detection condition.

In the image processing apparatus, a detection condition for specifying a range of at least one of the number, sizes and positions of organ areas to be detected upon organ area detection is set on the basis of a detection result of a face area, and the organ area satisfying the set detection condition is detected. Accordingly, the accuracy of a process of detecting an organ area in an image is improved and the efficiency of the detecting process is increased.

In the image processing apparatus according to this aspect, the face area detecting unit evaluates a certainty that an image area on the target image is an image area corresponding to a face image by using face evaluating data generated using a sample image including the face image to detect the face area. The detection condition setting unit sets the detection condition on the basis of a relationship associated with at least one of the number, sizes and positions between the face area and the organ areas, which is set in advance on the basis of facial organ images in the sample image used for the generation of the face evaluating data.

In the image processing apparatus, the detection condition is set on the basis of a relationship associated with at least one of the number, sizes and positions between the face area and the organ areas, which is set in advance on the basis of facial organ images in the sample image used for the generation of the face evaluating data. Accordingly, the accuracy of a process of detecting an organ area in an image is improved and the efficiency of the detecting process is increased.

In the image processing apparatus according to this aspect, the face evaluating data is associated with a face direction that is a rotation angle about an axis that is parallel to an image plane of a face image in the sample image used for the generation of the face evaluating data. The relationship between the face area and the organ areas is set for each face direction associated with the face evaluating data. The detection condition setting unit sets the detection condition on the basis of the relationship corresponding to the face direction associated with the face evaluating data used for the detection of the face area.

In the image processing apparatus, the detection condition is set on the basis of the relationship corresponding to a face direction associated with the face evaluating data used for the detection of the face area. Accordingly, the accuracy of a process of detecting an organ area in an image is improved and the efficiency of the detecting process is increased.

In the image processing apparatus according to this aspect, the organ area detecting unit includes: a determination target setting unit that sets a determination target image area that is an image area in the face area, a storing unit that stores organ evaluating data for calculating an evaluated value representing a certainty that the determination target image area is an image area corresponding to a facial organ image, an evaluated value calculating unit that calculates the evaluated value on the basis of the organ evaluating data and image data corresponding to the determination target image area, and an area setting unit that sets the organ area on the basis of the evaluated value and the size and position of the determination target image area. The determination target setting unit determines at least one of the number, sizes and positions of the determination target image areas to be set on the basis of the relationship between the face area and the organ areas.

In the image processing apparatus, at least one of the number, sizes and positions of the determination target image areas to be set is determined on the basis of the relationship between the face area and the organ areas. Accordingly, the accuracy of a process of detecting an organ area in an image is improved and the efficiency of the detecting process is increased.

In the image processing apparatus according to this aspect, the face evaluating data is generated by learning using the sample image.

In the image processing apparatus, the detection condition is set on the basis of the relationship associated with at least one of the number, sizes and positions between the face area and the organ areas, which is set in advance on the basis of facial organ images in the sample image used for the generation of the face evaluating data by learning. Accordingly, the accuracy of a process of detecting an organ area in an image is improved and the efficiency of the detecting process is increased.

In the image processing apparatus according to this aspect, the detection condition setting unit sets the detection condition depending on the kind of a facial organ corresponding to the organ area to be detected.

In the image processing apparatus, the accuracy of a process of detecting an organ area in an image is improved and the efficiency of the detecting process is increased depending on the kind of a facial organ.

In the image processing apparatus according to this aspect, the organ area detecting unit detects a plurality of candidates of the organ area to determine the organ area on the basis of geometric relationships between the plurality of candidates.

In the image processing apparatus, a plurality of candidates of the organ area is detected and the organ area is determined on the basis of geometric relationships between the plurality of candidates. Accordingly, the accuracy of a process of detecting an organ area in an image is improved and the efficiency of the detecting process is increased.

In the image processing apparatus according to this aspect, the facial organ is at least one of a right eye, a left eye and a mouth.

In the image processing apparatus, the accuracy of a process of detecting an organ area corresponding to at least one of the right eye, the left eye, and the mouth in the image is improved and the efficiency of the detecting process is increased.

The invention can be embodied in various forms. For example, the invention can be embodied as an image processing method and apparatus, an organ area detecting method and apparatus, a computer program for executing the functions of the apparatuses or methods, a recording medium having the computer program recorded thereon, and the like.

### BRIEF DESCRIPTION OF THE DRAWINGS

The invention will be described with reference to the accompanying drawings, wherein like numbers reference like elements.

FIG. 1 is a block diagram of a printer according to a first embodiment of the invention.

FIGS. 2A-2H are diagrams illustrating kinds of face learning data FLD and facial organ learning data OLD.

FIG. 3 is a flowchart of a face area and organ area detecting process according to the first embodiment.

FIG. 4 is a flowchart of the face area detecting process.

FIG. 5 is a diagram illustrating an outline of the face area detecting process.

FIG. 6 is a diagram illustrating an outline of a method of calculating a cumulative evaluated value used for face determination.

FIG. 7 is a diagram illustrating sample images used for learning for setting the face learning data FLD corresponding to a face in the front direction.

FIGS. 8A and 8B are diagrams illustrating an outline of a face area determining process.

FIGS. 9A-9C are diagrams illustrating the outline of the face area determining process.

FIGS. 10A and 10B are diagrams illustrating an outline of a detection condition setting method.

FIGS. 11A and 11B are diagrams illustrating an outline of the detection condition setting method.

FIG. 12 is a flowchart of an organ area detecting process.

FIG. 13 is a diagram illustrating an outline of the organ area detecting process.

FIGS. 14A and 14B are diagrams illustrating the outline of the organ area detecting process.

FIG. 15 is a flowchart of a window determining process according to a second embodiment of the invention.

FIG. 16 is a flowchart of the window determining process according to the second embodiment of the invention.

FIGS. 17A and 17B are diagrams illustrating the outline of the window determining process according to the second embodiment of the invention.

### DESCRIPTION OF EXEMPLARY EMBODIMENTS

Exemplary embodiments of the invention are now described in the following order:
A. First Embodiment
A-1. Structure of Image Processing Apparatus,
A-2. Face Area and Organ Area Detecting Process,
B. Second Embodiment, and
C. Modified Examples

### A. First Embodiment

### A-1. Structure of Image Processing Apparatus

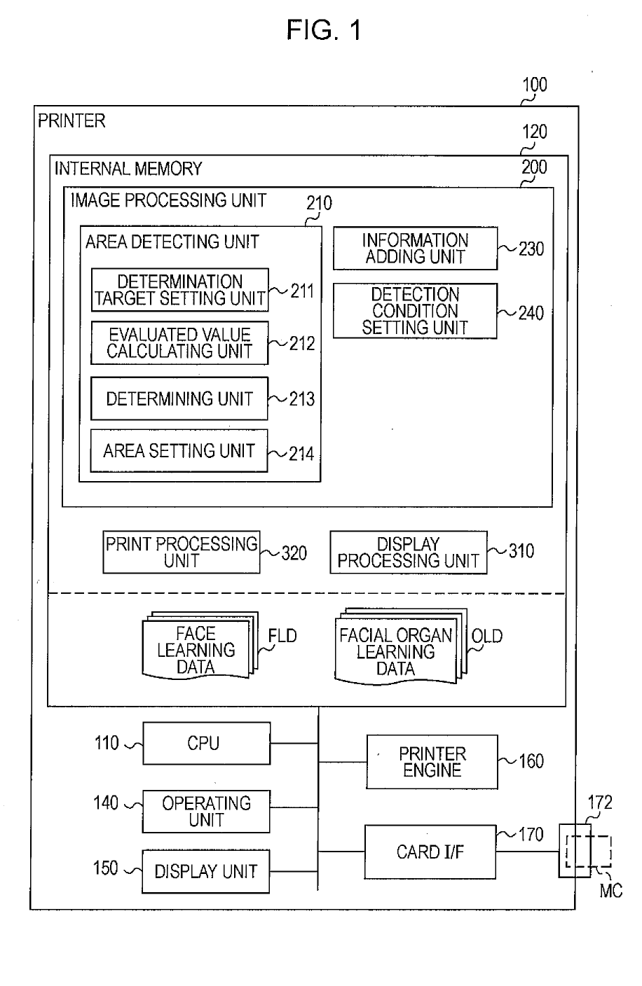

FIG. 1 is a block diagram of a printer 100, which is an image processing apparatus according to a first embodiment of the invention. The printer 100 according to the first embodiment is an ink jet color printer corresponding to so-called direct printing that performs image printing on the basis of image data obtained from a memory card MC or the like. The printer 100 includes a CPU 110 that controls all components of the printer 100, an internal memory 120 that is composed of a ROM or a RAM, an operating unit 140 that includes buttons or a touch panel, a display unit 150 that is composed of a liquid crystal display, a printer engine 160, and a card interface (card I/F) 170. The printer 100 may further include interfaces for data communication with other apparatuses (for example, a digital still camera and a personal computer). The components of the printer 100 are connected to one another by a bus.

The printer engine 160 is a printing mechanism that performs printing on the basis of print data. The card interface 170 is an interface for data communication with the memory card MC inserted into a card slot 172. In this embodiment, image files including image data are stored in the memory card MC.

The internal memory 120 includes an image processing unit 200, a display processing unit 310, and a print processing unit 320. The image processing unit 200 is a computer program for performing a face area and organ area detecting process under a predetermined operating system. The display processing unit 310 is a display driver that controls the display unit 150 to display, for example, a process menu, a message, or an image on the display unit 150. The print processing unit 320 is a computer program that generates print data from image data and controls the printer engine 160 to print images on the basis of the print data. The CPU 110 reads these programs from the internal memory 120 and executes the read programs to implement the functions of the above-mentioned units.

The image processing unit 200 includes an area detecting unit 210, an information adding unit 230, and a detection condition setting unit 240 as program modules. The area detecting unit 210 detects an image area (a face area and an organ area) corresponding to a predetermined kind of subject image (a face image and a facial organ image) in an image indicated by image data. The area detecting unit 210 includes a determination target setting unit 211, an evaluated value calculating unit 212, a determining unit 213 and an area setting unit 214. The area detecting unit 210 serves as a face area detecting unit and an organ area detecting unit according to the invention in order to detect a face area corresponding to a face image and an organ area corresponding to a facial organ image.

The information adding unit 230 adds predetermined information to image files including image data. On the basis of a result of the face area detecting process, the detection condition setting unit 240 sets detection conditions for specifying ranges of the number, sizes and positions of organ areas to be detected upon detection of the organ area

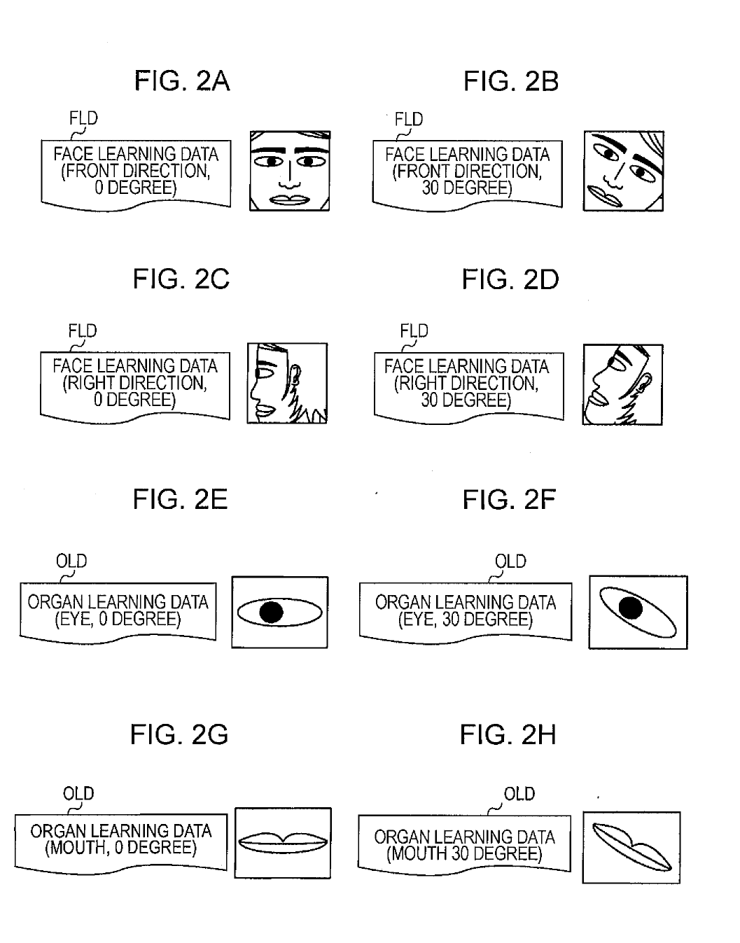

The internal memory 120 stores a plurality of preset face learning data FLD and facial organ learning data OLD. The face learning data FLD and the facial organ learning data OLD are used for the area detecting unit 210 to detect a face area and an organ area. FIGS. 2A-2H are diagrams illustrating kinds of face learning data FLD and facial organ learning data OLD and examples of image areas detected by these kinds of face learning data FLD and facial organ learning data OLD.

Face learning data FLD is set to correspond to a combination of a face inclination and a face direction. The face inclination is the inclination (rotation angle) of a face in an image plane. That is, the face inclination is the rotation angle of a face about an axis that is vertical to the image plane. In this embodiment, when a state in which the upper direction of an area or subject is aligned with the upper direction of a target image is referred to as the reference state (inclination=0 degrees), the inclination of the area or subject on the target image is represented by a rotation angle from the reference state in the clockwise direction. For example, when a state in which a face is disposed in a vertical direction of a target image (the top of a head faces upward and a jaw faces downward) is referred to as the reference state (face inclination=0 degrees), the face inclination is represented by a rotation angle of the face from the reference state in the clockwise direction.

The face direction is the direction of a face out of an image plane (the angle of the aspect of a face). The aspect of a face is the direction of a face with respect to an axis of a substantially cylindrical head. That is, the face direction is the rotation angle of a face about an axis that is parallel to the image plane. In this embodiment, a “front direction” means that a face looks directly at an imaging surface of an image generating apparatus such as a digital still camera, a “right direction” means that a face turns to the right side of the imaging surface (the image of a face that turns to the left as viewed from a viewer of the image), and a “left direction” means that a face turns to the left side of the imaging surface (the image of a face that turns to the right as viewed from a viewer of the image).

The internal memory 120 stores four face learning data FLD shown in FIGS. 2A-2D: face learning data FLD corresponding to a combination of a face in the front direction and a face inclination of 0 degrees (FIG. 2A); face learning data FLD corresponding to a combination of a face in the front direction and a face inclination of 30 degrees (FIG. 2B); face learning data FLD corresponding to a combination of a face in the right direction and a face inclination of 0 degrees (FIG. 2C); and face learning data FLD corresponding to a combination of a face in the right direction and a face inclination of 30 degrees (FIG. 2D). A face in a front direction and a face in a right or left direction may be analyzed as different kinds of subjects. In this case, the face learning data FLD can be expressed in correspondence with a combination of the kind and the inclination of the subject.

Face learning data FLD corresponding to a certain face inclination is set by learning such that an image of a face that is inclined in the range of +15 to −15 degrees from the face inclination can be detected. In addition, a person's face is substantially symmetric with respect to the vertical direction. Therefore, when two face learning data, that is, face learning data FLD corresponding to a face inclination of 0 degrees (FIG. 2A) and face learning data FLD corresponding to a face inclination of 30 degrees (FIG. 2B), are prepared in advance for a face in the front direction, it is possible to obtain face learning data FLD capable of detecting a face image in the entire face inclination range by rotating the two face learning data FLD at every 90 degrees. Similarly, when two face learning data, that is, face learning data FLD corresponding to a face inclination of 0 degree (FIG. 2C) and face learning data FLD corresponding to a face inclination of 30 degrees (FIG. 2D), are prepared in advance for a face in the right direction, it is possible to obtain face learning data FLD capable of detecting a face image in the entire face inclination range. In addition, for a face in the left direction, it is possible to obtain face learning data FLD capable of detecting a face image in the entire face inclination range by inverting the face learning data FLD corresponding to the face in the right direction.

Facial organ learning data OLD is set to correspond to a combination of the kind of facial organ and an organ inclination. In this embodiment, eyes (right and left eyes) and a mouth are set as the kinds of facial organs. In addition, the organ inclination is the inclination (rotation angle) of a facial organ in an image plane, as in the above-described face inclination. That is, the organ inclination is the rotation angle of a facial organ about an axis that is vertical to the image plane. When a state in which a facial organ is disposed in a vertical direction of a target image is referred to as the reference state (organ inclination=0 degrees), the organ inclination is represented by the rotation angle of the facial organ from the reference state in the clockwise direction, as with the face inclination.

The internal memory 120 stores four facial organ learning data OLD shown in FIGS. 2E-2H: facial organ learning data OLD corresponding to a combination of an eye and an organ inclination of 0 degrees shown (FIG. 2E), facial organ learning data OLD corresponding to a combination of an eye and an organ inclination of 30 degrees (FIG. 2F); facial organ learning data OLD corresponding to a combination of a mouth and an organ inclination of 0 degrees (FIG. 2G); and facial organ learning data OLD corresponding to a combination of a mouth and an organ inclination of 30 degrees (FIG. 2H). The eyes and the mouth are different kinds of subjects and thus the facial organ learning data OLD can be expressed in correspondence with a combination of the kind and the inclination of the subject.

As in the case of the face learning data FLD, facial organ learning data OLD corresponding to a certain organ inclination is set by learning such that an image of an organ that is inclined in the range of +15 to −15 degrees from the organ inclination can be detected. In addition, a person's eyes and mouth are substantially symmetric with respect to the vertical direction. Therefore, when two facial organ learning data, that is, facial organ learning data OLD (FIG. 2E) corresponding to an organ inclination of 0 degrees and facial organ learning data OLD (FIG. 2F) corresponding to an organ inclination of 30 degrees, are prepared in advance for an eye, it is possible to obtain facial organ learning data OLD capable of detecting an eye image in the entire organ inclination range by rotating the two facial organ learning data OLD at every 90 degrees. Similarly, when two facial organ learning data, that is, facial organ learning data OLD (FIG. 2G) corresponding to an organ inclination of 0 degrees and facial organ learning data OLD (FIG. 2H) corresponding to an organ inclination of 30 degrees, are prepared in advance for a mouth, it is possible to obtain facial organ learning data OLD capable of detecting a mouth image in the entire organ inclination range. In this embodiment, the right and left eyes are regarded as the same kind of subject, and a right eye area corresponding to an image of the right eye and a left eye area corresponding to an image of the left eye are detected using common facial organ learning data OLD. However, the right and left eyes may be regarded as different kinds of subjects and dedicated facial organ learning data OLD for detecting the right eye area and the left eye area may be prepared.

### A-2. Face Area and Organ Area Detecting Process

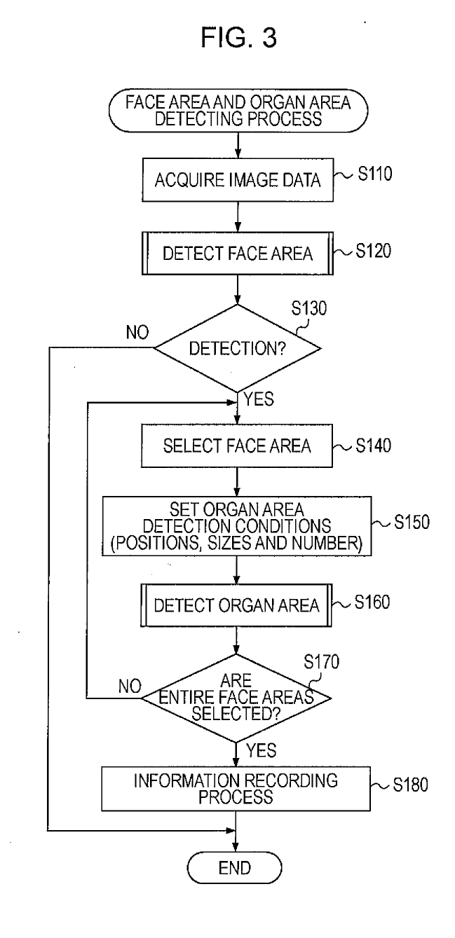

FIG. 3 is a flowchart of the face area and organ area detecting process according to the first embodiment. The face area and organ area detecting process according to this embodiment detects a face area corresponding to a face image in an image indicated by image data and an organ area corresponding to a facial organ in the face area. The detected face and organ areas can be used in a predetermined image process (for example, flesh color correction, red eye correction, deformation of a face image and detection of a facial expression (such as a smile)).

In Step S110, the image processing unit 200 acquires image data indicating an image as a target of the face area and organ area detecting process. In the printer 100 according to this embodiment, when the memory card MC is inserted into the card slot 172, thumbnail images of image files stored in the memory card MC are displayed by the display unit 150. The user uses the operating unit 140 to select one or more images to be processed while referring to the displayed thumbnail images. The image processing unit 200 acquires an image file including image data corresponding to the selected one or more images from the memory card MC and stores the acquired image file in a predetermined area of the internal memory 120. The acquired image data is referred to as the original image data, and an image represented by the original image data is referred to as the original image OImg.

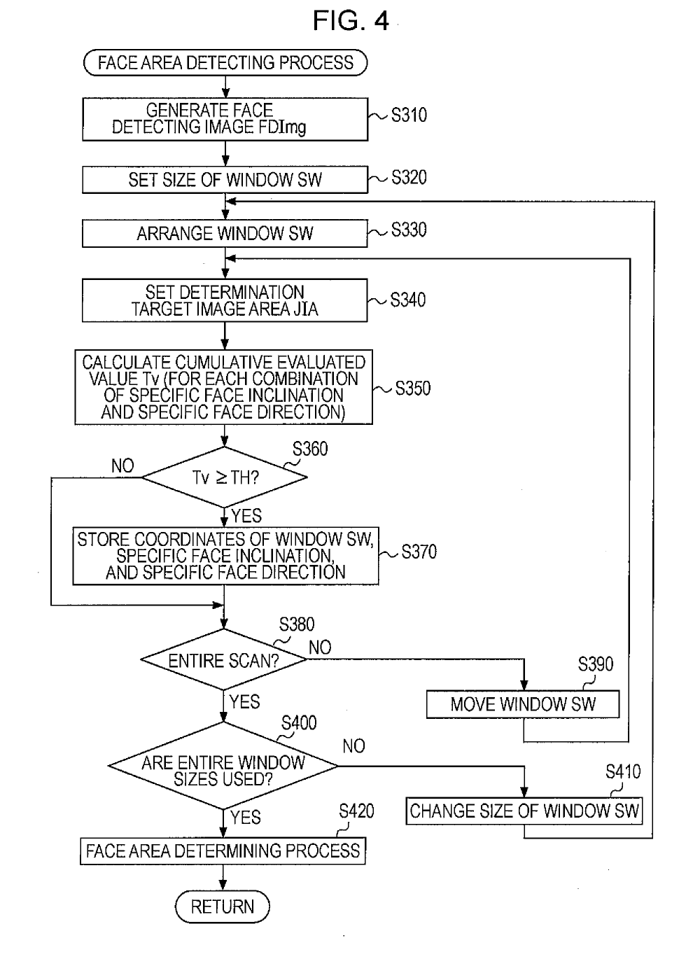

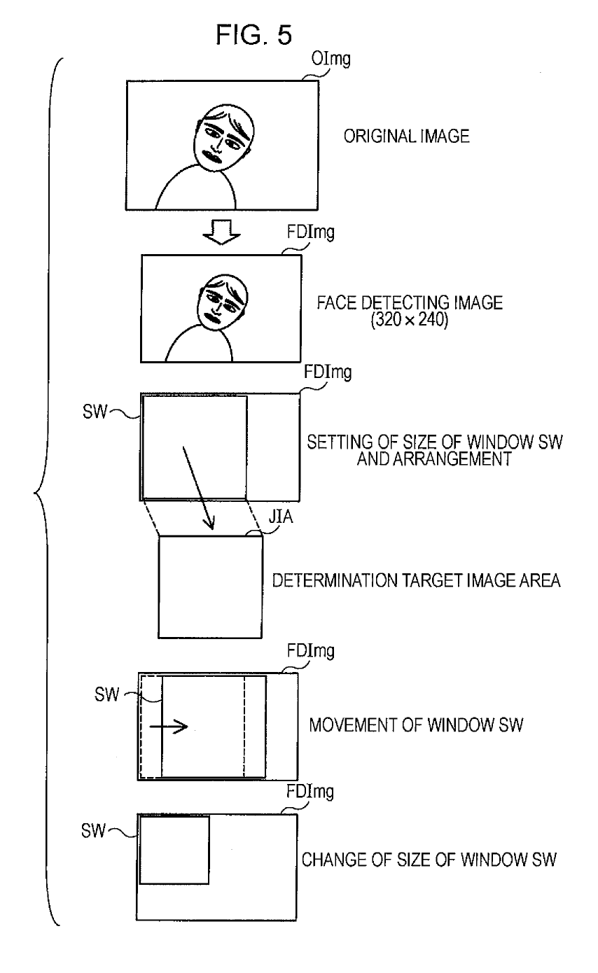

In Step S120, the area detecting unit 210 performs the face area detecting process, in which an image area corresponding to a face image is detected as a face area FA. FIG. 4 is a flowchart of the face area detecting process, and FIG. 5 illustrates an outline of the face area detecting process. In FIG. 5, the uppermost portion shows an example of the original image OImg.

In Step S310 of the face area detecting process (FIG. 4), the area detecting unit 210 generates face detecting image data indicating a face detecting image FDImg from the original image data indicating the original image OImg. In this embodiment, as illustrated in FIG. 5, the face detecting image FDImg has a size of horizontal 320 pixels×vertical 240 pixels. The area generating unit 210 changes the resolution of the original image data to generate face detecting image data indicating the face detecting image FDImg, if necessary.

In Step S320 (FIG. 4), the determination target setting unit 211 sets the size of a window SW for setting a determination target image area JIA to an initial value. In Step S330, the determination target setting unit 211 arranges the window SW at an initial position on the face detecting image FDImg. In Step S340, the determination target setting unit 211 sets an image area defined by the window SW arranged on the face detecting image FDImg to the determination target image area JIA that is a target for the determination whether to be an image area corresponding to a face image (hereinafter, referred to as “face determination”). In FIG. 5, a middle portion shows the arrangement of the window SW having an initial size at the initial position on the face detecting image FDImg and the setting of the image area defined by the window SW to the determination target image area JIA. In this embodiment, the size and position of the square window SW are changed and then the determination target image area JIA is set. The initial value of the size of the window SW is horizontal 240 pixels x vertical 240 pixels, which is a maximum size, and the initial position of the window SW is set such that the upper left corner of the window SW overlaps the upper left corner of the face detecting image FDImg. In addition, the window SW is arranged such that an inclination thereof is 0 degrees. As described above, when a state in which the upper direction of the window SW is aligned with the upper direction of a target image (face detecting image FDImg) is referred to as the reference state (inclination=0 degrees) the inclination of the window SW is the rotation angle of the window SW from the reference state in the clockwise direction.

In Step S350, the evaluated value calculating unit 212 calculates a cumulative evaluated value Tv used for the face determination for the determination target image area JIA, on the basis of image data corresponding to the determination target image area JIA. In this embodiment, the face determination is performed for each combination of a predetermined specific face inclination and a predetermined specific face direction. That is, it is determined whether the determination target image area JIA is an image area corresponding to a face image having a specific face inclination and a specific face direction for each combination of the specific face inclination and the specific face direction. Therefore, the cumulative evaluated value Tv is calculated for each combination of a specific face inclination and a specific face direction. The specific face inclination is a predetermined face inclination. In this embodiment, total twelve face inclinations (0, 30, 60, . . . , and 330 degrees) including a reference face inclination (face inclination=0 degrees) and face inclinations that are arranged at an angular interval of 30 degrees from the reference face inclination are set as the specific face inclinations. In addition, the specific face direction is a predetermined face direction. In this embodiment, a total of three face directions, the front, right and left directions, are set as the specific face directions.

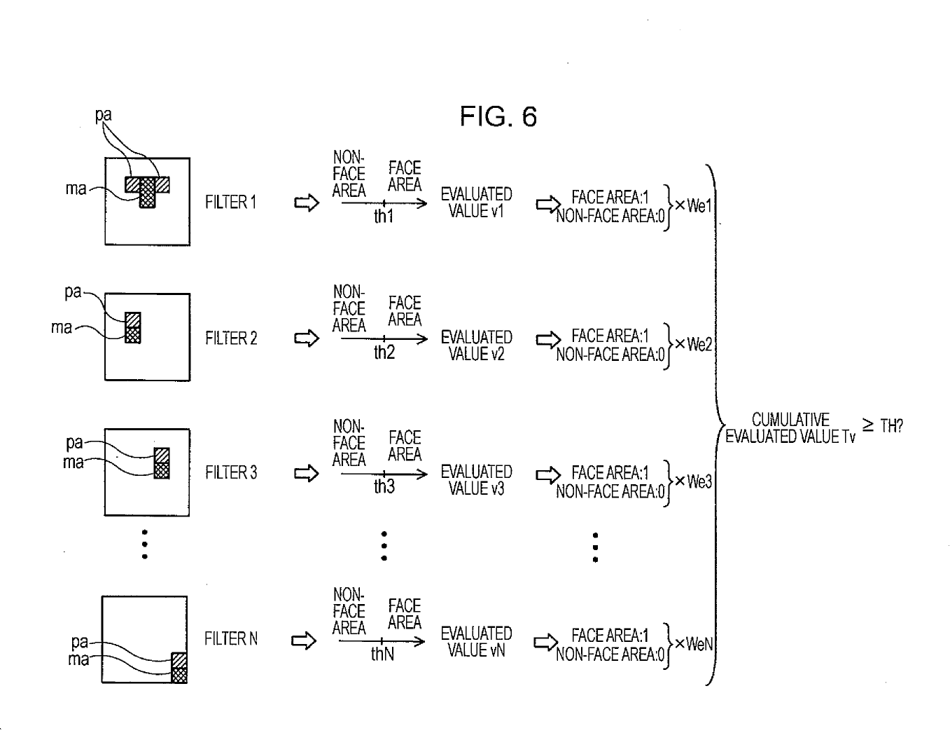

FIG. 6 illustrates a method of calculating the cumulative evaluated value Tv used for the face determination. In this embodiment, N filters (filters 1-N) are used to calculate the cumulative evaluated value Tv. Each of the filters has the same aspect ratio as the window SW (that is, each of the filters has a square shape), and a positive area pa and a negative area ma are set in each of the filters. The evaluated value calculating unit 212 sequentially applies a filter X (X=1, 2, . . . , N) to the determination target image area JIA to calculate an evaluated value vX (that is, v1-vN). Specifically, the evaluated value vX is obtained by subtracting the sum of the brightness values of pixels in a portion of the determination target image area JIA corresponding to the negative area ma of the filter X from the sum of the brightness values of pixels in another portion of the determination target image area JIA corresponding to the positive area pa of the filter X.

The calculated evaluated value vX is compared with a threshold value thX (that is, th1-thN) that is set to correspond to the evaluated value vX. In this embodiment, if the evaluated value vX is equal to or larger than the threshold value thX, it is determined that the determination target image area JIA is an image area corresponding to a face image for the filter X, and the output value of the filter X is set to “1”, On the other hand, if the evaluated value vX is smaller than the threshold value thX, it is determined that the determination target image area JIA is not an image area corresponding to a face image for the filter X, and the output value of the filter X is set to “0”. A weighting coefficient WeX (that is, We1-WeN) is set in each filter X, and the sum of the products of the output values and the weighting coefficients WeX of all the filters is calculated as the cumulative evaluated value Tv.

The aspect of the filter X, the threshold value thX, the weighting coefficient WeX, and a threshold value TH used for the face determination are defined as the face learning data FLD in advance. That is, for example, the aspect of the filter X, the threshold value thX, the weighting coefficient WeX, and the threshold value TH defined as the face learning data FLD (see FIG. 2A) corresponding to a combination of a face in the front direction and a face inclination of 0 degrees are used to calculate the cumulative evaluated value Tv corresponding to the combination of a face in the front direction and a face inclination of 0 degrees and perform the face determination. Similarly, the face learning data FLD (see FIG. 2B) corresponding to a combination of a face in the front direction and a face inclination of 30 degrees is used to calculate the cumulative evaluated value Tv corresponding to the combination of a face in the front direction and a face inclination of 30 degrees and perform the face determination. In addition, in order to calculate the cumulative evaluated value Tv corresponding to a combination of a face in the front direction and another specific face inclination and perform the face determination, the evaluated value calculating unit 212 generates face learning data FLD corresponding to the combination of a face in the front direction and another specific face inclination, on the basis of the face learning data FLD (FIG. 2A) corresponding to the combination of a face in the front direction and a face inclination of 0 degrees and the face learning data FLD (FIG. 2B) corresponding to the combination of a face in the front direction and a face inclination of 30 degrees, and uses the generated face learning data FLD. Necessary face learning data FLD is generated for a face in the right direction and a face in the left direction on the basis of the face learning data FLD stored in advance in the internal memory 120 by the same method as described above, and is used. The face learning data FLD according to this embodiment is data for evaluating a certainty that the determination target image area JIA is an image area corresponding to a face image. Therefore, the face learning data FLD corresponds to evaluating data according to the invention.

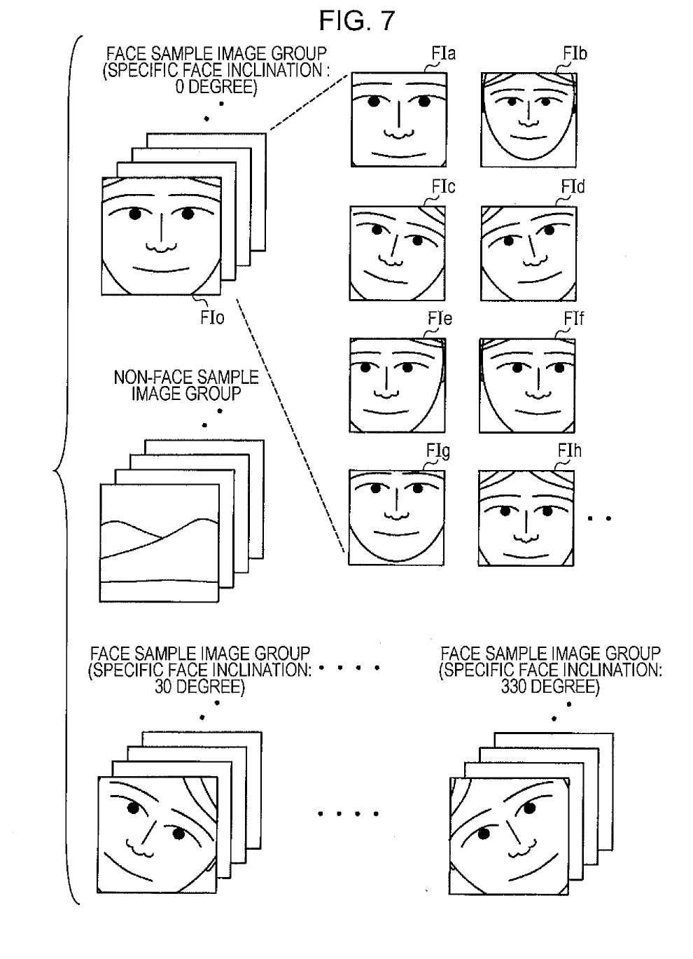

The face learning data FLD is set (generated) by learning using sample images. FIG. 7 illustrates sample images used for learning for setting the face learning data FLD corresponding to a face in the front direction. The following are used for learning: a face sample image group including a plurality of face sample images that have been known to correspond to a face in the front direction; and a non-face sample image group including a plurality of non-face sample images that have been known not to correspond to a face in the front direction.

The setting of the face learning data FLD corresponding to the face in the front direction by learning is performed for every specific face inclination. Therefore, as illustrated in FIG. 7, face sample image groups corresponding to 12 specific face inclinations are prepared. For example, the face learning data FLD for a specific face inclination of 0 degrees is set using a non-face sample image group and a face sample image group corresponding to the specific face inclination of 0 degrees, and the face learning data FLD for a specific face inclination of 30 degrees is set using a non-face sample image group and a face sample image group corresponding to the specific face inclination of 30 degrees.

The face sample image group corresponding to each specific face inclination includes a plurality of face sample images (hereinafter, also referred to as “basic face sample images FIo”) in which the ratio of the size of a face image to an image size is within a predetermined range and the inclination of the face image is equal to a specific face inclination. In addition, the face sample image group includes images (for example, images FIa and FIb of FIG. 7) in which at least one basic face sample image FIo is reduced and enlarged at a predetermined magnification of 0.8 to 1.2, images (for example, images FIc and FId of FIG. 7) in which the face inclination of the basic face sample image FIo is changed in the angular range of −15 to +15 degrees and images (for example, images FIe and FIh of FIG. 7) in which the position of a face image in the basic face sample image FIo is moved by a predetermined movement amount from side to side and up and down.

Learning using the sample images is performed by, for example, a method using a neural network, a method using boosting (for example, adaboosting), or a method using a support vector machine. For example, when learning is performed by using a neural network, the evaluated value vX (that is, v1-vN) is calculated for each filter X (that is, for each filter 1-N (see FIG. 6)) using all the sample images included in a non-face sample image group and a face sample image group corresponding to a certain specific face inclination, and the threshold value thX (that is, th1-thN) that achieves a predetermined face detection ratio is set. The face detection ratio is the ratio of the number of face sample images that are determined as images corresponding to a face image by threshold value determination using the evaluated value vX to the total number of face sample images in the face sample image group.

The weighting coefficient WeX (that is, We1-WeN) set for each filter X is then set to an initial value, and the cumulative evaluated value Tv for one sample image selected from the face sample image group and the non-face sample image group is calculated. In the face determination, when the cumulative evaluated value Tv calculated for a certain image is equal to or larger than a predetermined threshold value TH, the image is determined to correspond to the face image. In the learning process, the value of the weighting coefficient Wex set for each filter X is corrected on the basis of the determination result of a threshold value by the cumulative evaluated value Tv calculated for the selected sample image (a face sample image or a non-face sample image). Then, the selection of a sample image, the determination of a threshold value by the cumulative evaluated value Tv calculated for the selected sample image, and the correction of the value of the weighting coefficient WeX on the basis of the determination result are repeatedly performed on all the sample images in the face and non-face sample image groups. In this manner, the face learning data FLD corresponding to a combination of a face in the front direction and a specific face inclination is set.

Similarly, the face learning data FLD corresponding to another specific face direction (right or left direction) is set by learning using a face sample image group including a plurality of face sample images that have been known as images corresponding to a face in the right direction (or in the left direction) and a non-face sample image group including a plurality of non-face sample images that have been known as images not corresponding to a face in the right direction (or left direction).

When the cumulative evaluated value Tv is calculated for each combination of specific face inclination and specific face direction for the determination target image area JIA (Step S350 of FIG. 4), the determining unit 213 compares the cumulative evaluated value Tv with the threshold value TH that is set for each combination of specific face inclination and specific face direction (Step S360). If the cumulative evaluated value Tv is equal to or larger than the threshold value TH set for each combination of a specific face inclination and a specific face direction, the area detecting unit 210 determines that the determination target image area JIA is an image area corresponding to a face image having the specific face inclination and the specific face direction, and stores the position of the determination target image area JIA, that is, the coordinates of the window SW that is currently set, the specific face inclination, and the specific face direction (Step S370). If the cumulative evaluated value Tv is smaller than the threshold value TH for any combination of specific face inclination and specific face direction, Step S370 is skipped.

In Step S380 (FIG. 4), the area detecting unit 210 determines whether the entire face detecting image FDImg is scanned by the window SW having a size that is currently set. If the entire face detecting image FDImg is not scanned yet, the determination target setting unit 211 moves the window SW in a predetermined direction by a predetermined movement amount (Step S390). A lower portion of FIG. 5 shows the movement of the window SW. In this embodiment, in Step S390, the window SW is moved to the right by a movement amount corresponding to 20% of the size of the window SW in the horizontal direction. When the window SW is disposed at a position where it cannot move any further to the right, in Step S390, the window SW returns to the left end of the face detecting image FDImg, and is moved down by a movement amount corresponding to 20% of the size of the window SW in the vertical direction. When the window SW is disposed at a position where it cannot move down any further, it is determined that the entire face detecting image FDImg is scanned. After the window SW is moved (Step S390), the processes after Step S340 are performed on the moved window SW.

When it is determined in Step S380 that the entire face detecting image FDImg is scanned by the window SW having the currently set size, it is determined whether all predetermined sizes of the window SW are used (Step S400). In this embodiment, the window SW has a total of 15 sizes, that is, a size of horizontal 240 pixels×vertical 240 pixels, which is an initial value (a maximum size), a size of horizontal 213 pixels×vertical 213 pixels, a size of horizontal 178 pixels×vertical 178 pixels, a size of horizontal 149 pixels×vertical 149 pixels, a size of horizontal 124 pixels×vertical 124 pixels, a size of horizontal 103 pixels×vertical 103 pixels, a size of horizontal 86 pixels×vertical 86 pixels, a size of horizontal 72 pixels×vertical 72 pixels, a size of horizontal 60 pixels×vertical 60 pixels, a size of horizontal 50 pixels×vertical 50 pixels, a size of horizontal 41 pixels×vertical 41 pixels, a size of horizontal 35 pixels×vertical 35 pixels, a size of horizontal 29 pixels×vertical 29 pixels, a size of horizontal 24 pixels×vertical 24 pixels, and a size of horizontal 20 pixels×vertical 20 pixels (a minimum size). If there is a size of the SW that is not used yet, the determination target setting unit 211 changes the size of the window SW from the currently set size to the next smaller size (Step S410). That is, the size of the window SW is set to the maximum size at the beginning and then is sequentially changed to the smaller size. After the size of the window SW is changed (Step S410), the processes after Step S330 are performed on the window SW whose size is changed,

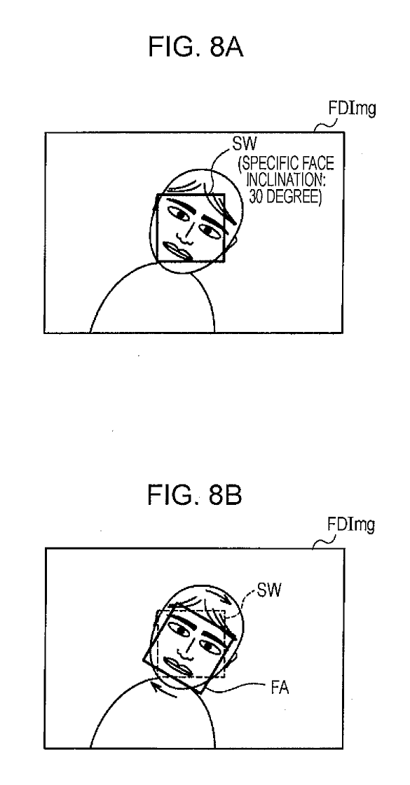

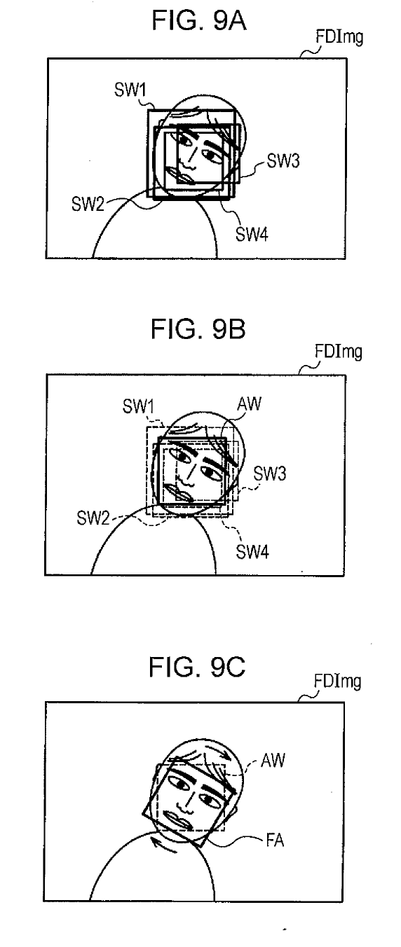

When it is determined in Step S400 that all predetermined sizes of the window SW are used, the area setting unit 214 performs a face area determining process (Step S420). FIGS. 8A and 8B and 9A-9C illustrate the face area determining process. When it is determined in Step S360 of FIG. 4 that the cumulative evaluated value Tv is equal to or larger than the threshold value TH, the area setting unit 214 determines the face area FA as an image area corresponding to the face image on the basis of the specific face inclination and the coordinates of the window SW stored in Step S370. Specifically, if the stored specific face inclination is 0 degrees, the image area (the determination target image area JIA) defined by the window SW is determined as the face area FA without any change. On the other hand, if the stored specific face inclination is not 0 degrees, the inclination of the window SW is changed to be equal to the specific face inclination (that is, the window SW is rotated on a predetermined point (for example, the center of gravity of the window SW) by the specific face inclination in the clockwise direction), and the image area defined by the window SW whose inclination is changed is determined as the face area FA. For example, as shown in FIG. 8A, if it is determined that the cumulative evaluated value Tv is equal to or larger than the threshold value TH for a specific face inclination of 30 degrees, as illustrated in FIG. 8E, the inclination of the window SW is changed by 30 degrees, and the image area defined by the window SW whose inclination is changed is determined as the face area FA.

In addition, when a plurality of windows SW that partially overlap each other for a specific face inclination are stored in Step S370 (FIG. 4), the area setting unit 214 sets a new window (“average window AW”) having an average value of the sizes of the windows SW, using average coordinates of the coordinates of predetermined points of the windows SW (for example, centers of gravity of the window SW) as the center of gravity. For example, as illustrated in FIG. 9A, when four windows SW (SW1-SW4) that partially overlap each other are stored, as illustrated in FIG. 9B, one average window AW having an average value of the sizes of the four windows SW is defined using average coordinates of the coordinates of the centers of gravity of the four windows SW as the center of gravity. At this time, as described above, when the stored specific face inclination is 0 degrees, the image area defined by the average window AW is determined as the face area FA without any change. On the other hand, when the stored specific face inclination is not 0 degrees, the inclination of the average window AW is changed to be equal to the specific face inclination (that is, the average window AW is rotated on a predetermined point (for example, the center of gravity of the average window AW) by the specific face inclination in the clockwise direction), and the image area defined by the average window AW whose inclination is changed is determined as the face area FA (see FIG. 9C).

As illustrated in FIGS. 8A and 8B, even when one window SW that does not overlap other windows SW is stored, the one window SW can be analyzed as the average window AW, as in the case in which the plurality of windows SW illustrated in FIGS. 9A-9C that partially overlap each other are stored.

In this embodiment, because the face sample image group (see FIG. 7) used for learning includes images obtained by reducing or enlarging the basic face sample image FIo at a magnification of 0.8 to 1.2 (for example, the images FIa and FIb in FIG. 7), the face area FA can be detected even when the size of the face image with respect to the size of the window SW is slightly larger or smaller than that of the basic face sample image FIo. Therefore, in this embodiment, even though only fifteen discrete sizes are set as the standard sizes of the window SW, it is possible to detect the face area FA in the face image having any size. Similarly, in this embodiment, since the face sample image group used for learning includes images obtained by changing the face inclination of the basic face sample image FIo in the angular range of −15 to +15 degrees (for example, the images FIc and FId in FIG. 7), the face area FA can be detected even when the inclination of the face image with respect to the window SW is slightly different from that of the basic face sample image FIo. Therefore, in this embodiment, even though only twelve discrete angles are set as the specific face inclinations, it is possible to detect the face area FA in the face image in the entire angular range.

In the face area detecting process (Step S120 of FIG. 3), when the face area FA is not detected (Step S130: No), the face area and organ area detecting process is completed. On the other hand, when at least one face area FA is detected (Step S130: Yes), the area detecting unit 210 selects one of the detected face areas FA (Step S140).

In Step S150, on the basis of the result of the face area detecting process (Step S120), the detection condition setting unit 240 sets detection conditions for specifying ranges of the number, sizes and positions of organ areas to be detected in the organ area detecting process (Step S160) to be described later. As described above, in this embodiment, eyes (right and left eyes) and a mouth are set as the kinds of facial organs and thus the detection of a right eye area EA(r) corresponding to a right eye image, a left eye area EA(l) corresponding to a left eye image and a mouth area MA corresponding to a mouth image is performed in the organ area detecting process (hereinafter, the right eye area EA(r) and the left eye area EA(l) are also collectively referred to as “eye area EA”). The setting of the detection conditions is performed for each of the eye area EA and the mouth area MA.

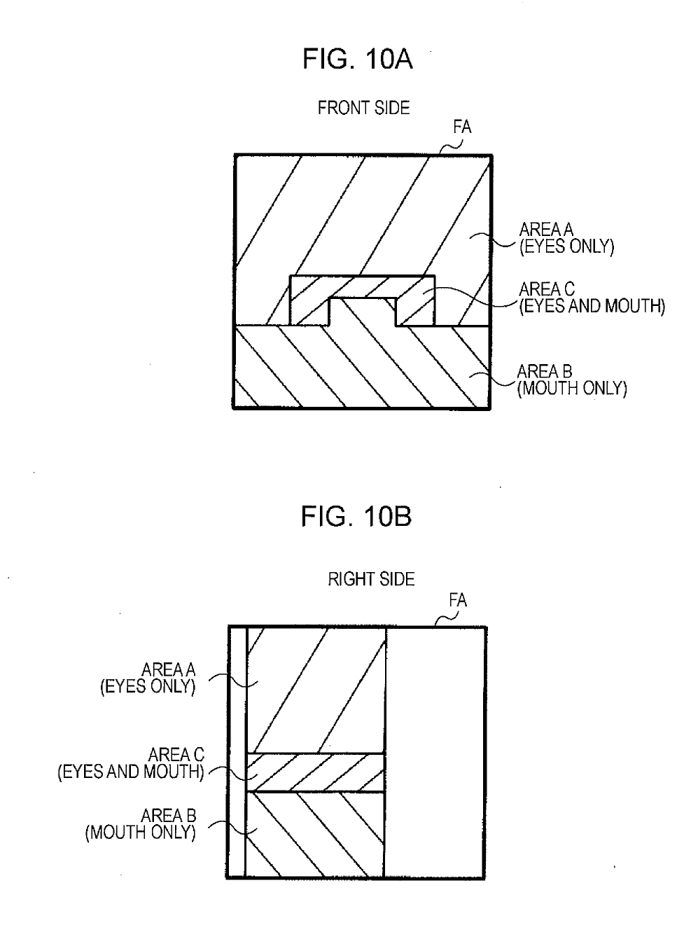

FIGS. 10A and 10B and FIGS., 11A and 11B are diagrams illustrating a method of setting the detection conditions. FIGS. 10A and 10B illustrate a method of setting the detection condition for the positions of organ areas. As illustrated in FIGS. 10A and 10B, upon setting of the detection condition for the positions of organ areas, three areas (areas A, B and C, hereinafter, also collectively referred to as a “position specification area”) are set in the selected face area FA. The areas A and C are ranges in which the eye area EA can be positioned and the areas B and C are ranges in which the mouth area MA can be positioned. In this embodiment, the positions of the areas are the positions of centers of gravity of the areas.

A positional relationship between the face area FA and the position specification area (areas A, B and C) is set in advance for each specific face direction (the front, right and left directions), and is stored in a predetermined area in the internal memory 120. FIG. 10A illustrates a positional relationship between the face area FA and the position specification area corresponding to a specific face direction that is the front direction, and FIG. 10B illustrates a positional relationship between the face area FA and the position specification area corresponding to a specific face direction that is the right direction. A positional relationship between the face area FA and the position specification area corresponding to a specific face direction that is the left direction is a relationship that is bilaterally symmetric with the relationship illustrated in FIG. 10B. The ranges in which the organ areas (eye area EA and mouth area MA) can be positioned are specified by the position specification area and thus it can be described that the positional relationship between the face area FA and the ranges in which the organ areas can be positioned is set in advance.

The positional relationship between the face area FA and the position specification area (areas A, B and C) is set for each specific face direction on the basis of the positions of facial organ images in the plurality of face sample images in the face sample image group (see FIG. 7) used for the setting of the face learning data VLD (see FIGS. 2A-2D). That is, for each specific face direction, the positions of the images of the eyes and mouth in the plurality of face sample images are checked to set as the area C an overlap portion of an area (“eye arrangeable area”) in the face area FA corresponding to the range of the position of the eye image in the face sample image and an area (“mouth arrangeable area”) in the face area FA corresponding to the range of the position of the mouth image in the face sample image. In addition, a portion not overlapping the area C in the eye arrangeable area is set as the area A and a portion overlapping the area C in the mouth arrangeable area is set as the area B.

The detection condition setting unit 240 specifies a specific face direction corresponding to the face learning data FLD used for the detection of the face area FA selected in Step S140 and sets the position specification area in the face area FA on the basis of the positional relationship (see FIGS. 10A and 10B) between the face area FA and the position specification area (areas A, B and C) corresponding to the specific face direction, thereby setting the detection condition for the positions of the organ areas.

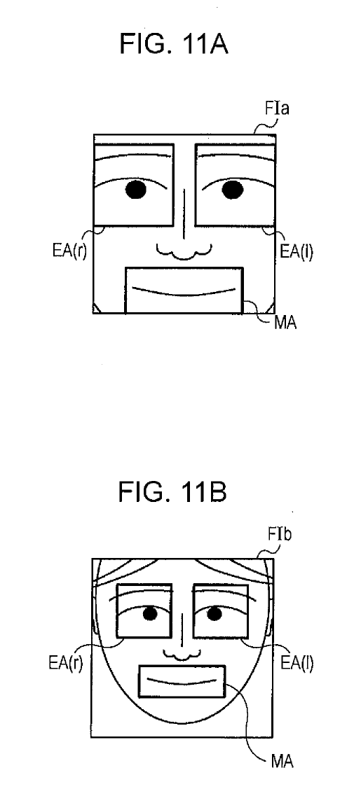

FIGS. 11A and 11B illustrate a method of setting the detection condition for the sizes of organ areas. In this embodiment, a range of the ratio of the sizes of the facial organ areas to the size of the face area FA is set in advance for each specific face direction (front, right and left directions), and is stored in a predetermined area in the internal memory 120. The range of the ratio of the sizes of the facial organ areas to the size of the face area FA is set for each specific face direction on the basis of the sizes of facial organ images in the plurality of face sample images in the face sample image group (see FIG. 7) used for the setting of the face learning data FLD (see FIGS. 2A-2D). That is, for each specific face direction, the sizes of the images of the eyes and mouths in the plurality of face sample images are checked to set a range of the ratio of the sizes of the images of the eyes and mouth to the size of the face sample image as the range of the ratio of the sizes of the organ areas to the size of the face area FA. FIG. 11A illustrates an image FIa having the largest sizes of eye and mouth images in the face sample image used for the setting of the face learning data FLD corresponding to a specific face direction that is the front direction, and FIG. 11B illustrates an image FIb having the smallest sizes of eye and mouth images in the face sample image used for the setting of the face learning data FLD corresponding to a specific face direction that is the front direction. In this case, a range from a ratio of the sizes of the organ areas (the right eye area EA(r), the left eye area EA(l) and the mouth area MA) to the size of the image FIb in the image FIb to a ratio of the sizes of the organ areas to the size of the image FIa in the image FIa is set as the range of the ratio of the sizes of the organ areas to the size of the face area FA.

The detection condition setting unit 240 specifies a specific face direction corresponding to the face learning data FLD used for the detection of the face area FA selected in Step S140, and sets a range of the ratio of the sizes of the organ areas to the size of the face area FA corresponding to the specific face direction to set the detection condition for the sizes of the organ areas.

In addition, the detection condition setting unit 240 sets the detection condition for the number of organ areas on the basis of the specific face direction corresponding to the face learning data FLD used for the detection of the face area FA selected in Step S140. Specifically, when the specific face direction is the front direction, the number of organ areas to be detected is set to 3, that is, the right eye area EA(r), the left eye area EA(l) and the mouth area MA. When the specific face direction is the right or left direction, the number of organ areas to be detected is set to 2, that is, the right eye area EA(r) (or left eye area EA(l)) and the mouth area MA.

In Step S160 (FIG. 3), the area detecting unit 210 performs the organ area detecting process. The organ area detecting process detects an image area corresponding to a facial organ image in the face area FA selected in Step S140 as an organ area. In the organ area detecting process according to this embodiment, the organ areas satisfying the detection conditions set in Step S150 are detected.

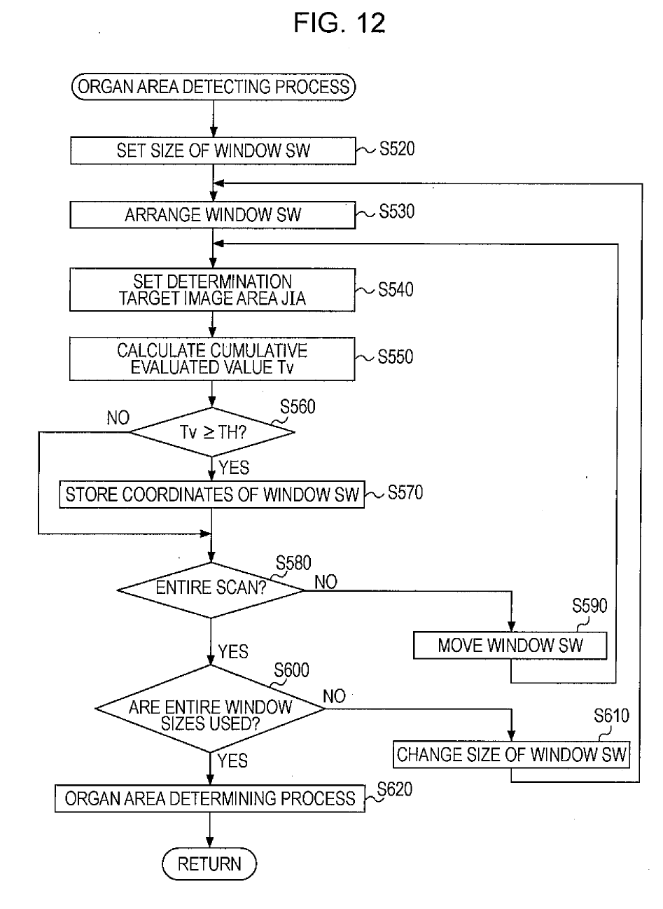

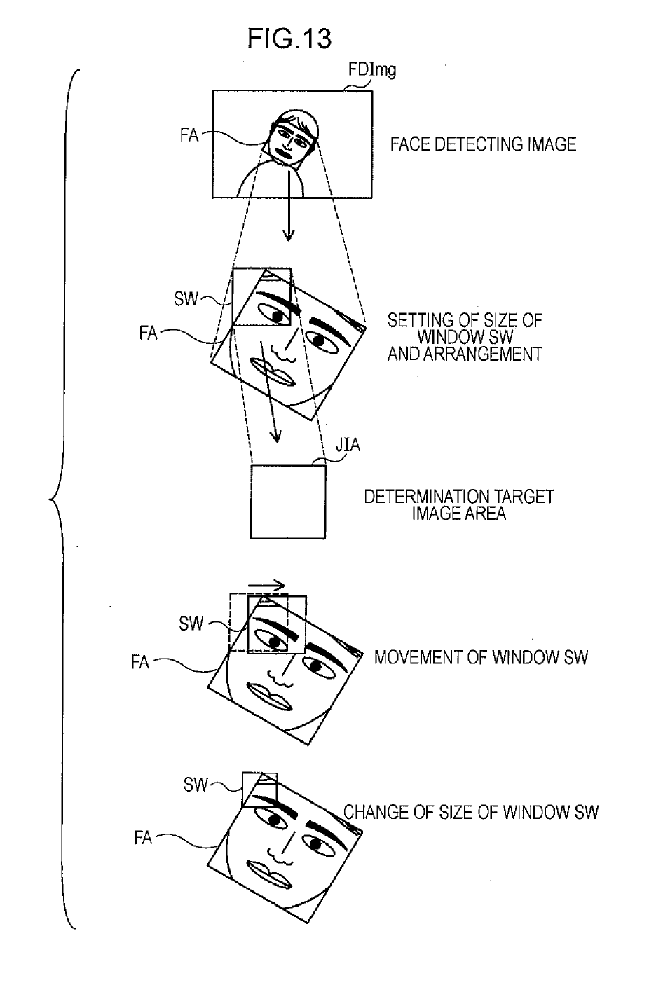

FIG. 12 is a flowchart of the organ area detecting process, and FIG. 13 is a diagram illustrating the organ area detecting process. In the uppermost portion of FIG. 13, an example of the face detecting image FDImg (see FIG. 5) used for the face detecting process is shown.

The detection of an organ area from the face detecting image FDImg is performed in the same manner as in the detection of the face area FA. That is, as illustrated in FIG. 13, a position and a size of a rectangular window SW is changed and then the window SW is arranged on the face detecting image FDImg (Steps S520, S530 and S580-S610 of FIG. 12) to be set as a determination target image area JIA that is a target for the determination of whether an image area defined by the arranged window SW is an organ area corresponding to a facial organ image (hereinafter, also referred to as “organ determination”) (Step S540 of FIG. 12). The position and size of the window SW is determined on the basis of the detection conditions set in Step S150. That is, the window SW is arranged in a range of the position of the organ area specified by the set detection condition. Specifically, upon detection of the eye area EA, the window SW is arranged so that a center of gravity thereof is disposed in the area A and the area B illustrated in FIGS. 10A and 10B. Upon detection of the mouth area MA, the window SW is disposed so that a center of gravity thereof is disposed in the area C and the area B illustrated in FIGS. 10A and 10B. The size of the window SW is set in a range of the size of the organ area specified by the set detection condition (see FIGS. 11A and 11B). By setting the position and size of the window SW in this manner, the organ area satisfying the set detection conditions is detected. The window SW is arranged in a state in which an inclination thereof is 0 degrees (a reference state in which the upper direction of the window SW is aligned with the upper direction of the face detecting image FDImg).

When the determination target image area JIA is set, a cumulative evaluated value Tv to be used for the organ determination is calculated for each facial organ (eyes and mouth) by using the facial organ learning data OLD (FIG. 1) (Step S550 of FIG. 12). The aspect of the filter X, the threshold value thX, the weighting coefficient WeX and the threshold value TH (see FIG. 6) used for the calculation of the cumulative evaluated value Tv and the organ determination are defined as the facial organ learning data OLD. As in learning for the setting of the face learning data FLD, learning for the setting of the facial organ learning data OLD is performed using an organ sample image group including a plurality of organ sample images that have been known to correspond to a facial organ and a non-organ sample image group including a plurality of non-organ sample images that have been known not to correspond to the facial organ.

In the face area detecting process (FIG. 4), the calculation of the cumulative evaluated value Tv and the face determination are performed at all the specific face inclinations. However, in the organ area detecting process (FIG. 12), the calculation of the cumulative evaluated value Tv and the organ determination are performed only at the same organ inclination as the specific face inclination of the face area FA by using the facial organ learning data OLD (see FIGS. 2E-2H) corresponding to the same organ inclination as the selected specific face inclination of the face area FA. In the organ area detecting process, the calculation of the cumulative evaluated value Tv and the organ determination may be performed at all the specific organ inclinations.

If the cumulative evaluated value Tv calculated is equal to or larger than a predetermined threshold value TH, the determination target image area JIA is regarded as an image area corresponding to an image of the organ in the face, and the position of the determination target image area JIA, that is, the coordinates of the window SW that is currently set are stored (Step S570 of FIG. 12). On the other hand, if the cumulative evaluated value Tv is smaller than the threshold value TH, Step S570 is skipped.

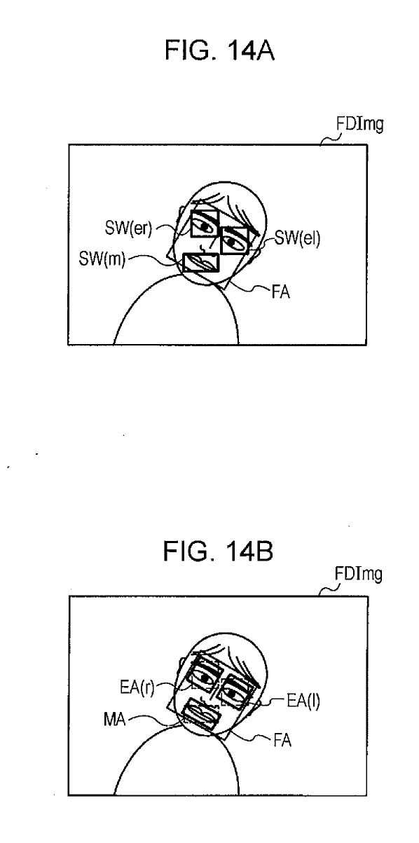

The entire range in which the window SW can be positioned is scanned with all sizes of the window SW, and then an organ area setting process is performed by the area setting unit 214 (Step S620 of FIG. 12). FIGS. 14A and 14B illustrate the organ area setting process. The organ area setting process is the same process as the face area setting process (see FIGS. 8A and 8B and FIGS. 9A-9C). The area setting unit 214 sets an organ area as an image area corresponding to a facial organ image on the basis of the specific face inclination corresponding to the face area FA and the coordinates of the window SW stored in Step S570 when it is determined that the cumulative evaluated value Tv is equal to or larger than the threshold value TH in Step S560 of FIG. 12. Specifically, if the specific face inclination is 0 degrees, the image area (the determination target image area JIA) defined by the window SW is set as the organ area without any change. On the other hand, if the specific face inclination is not 0 degrees, the inclination of the window SW is changed to be equal to the specific face inclination (that is, the window SW is rotated on a predetermined point (for example, the center of gravity of the window SW) by a specific face inclination in the clockwise direction), and the image area defined by the window SW whose inclination is changed is set as the organ area. For example, as illustrated in FIG. 14A, if the specific face inclination is 30 degrees and the cumulative evaluated value Tv is equal to or larger than the threshold value TH for each of a window SW (er) corresponding to the right eye, a window SW (el) corresponding to the left eye and a window SW (m) corresponding to the mouth, the inclinations of the windows SW are changed by 30 degrees as illustrated in FIG. 14B to set as the organ areas (the right eye area EA(r), the left eye area EA(l) and the mouth area MA) the image areas defined by the windows SW whose inclinations are changed.

As in the case of the face area setting process, when a plurality of windows SW that partially overlap each other are stored, a new window (average window AW) having an average value of the sizes of the windows SW is set using average coordinates of the coordinates of predetermined points (for example, centers of gravity of the windows SW) of the windows SW as the center of gravity. If the specific face inclination is 0 degrees, an image area defined by the average window AW is set as the organ area without any change, and if the specific face inclination is not 0 degrees, the inclination of the average window AW is changed to be equal to the specific face inclination (that is, the average window AW is rotated on a predetermined point (for example, the center of gravity of the average window AW) by a specific face inclination in the clockwise direction) and an image area defined by the average window AW whose inclination is changed is set as the organ area.

In Step S170 (FIG. 3), the area detecting unit 210 determines whether there is a face area FA that has not been selected yet in Step S140. If there is a face area FA that has not been selected yet (Step S170: No), the process returns to Step S140 to select one of the face areas FA that have not been selected, and the processes after Step S150 are performed. On the other hand, if it is determined that all the face areas FA are selected (Step S170: Yes), the process proceeds to Step S180.

In Step S180 (FIG. 3), the information adding unit 230 performs an information recording process for adding auxiliary information to an image file including the original image data. The information adding unit 230 stores as the auxiliary information the information (information indicating the positions (coordinates) of the face area and the organ area in the original image OImg) specifying the detected face area and organ area in an auxiliary information storing area for the image film including the original image data. The information adding unit 230 may also store information indicating the sizes of the face area and the organ area and information indicating the inclinations of the face area and the organ area in the original image OImg in the auxiliary information storing area.

As described above, in the face area and organ area detecting process of the printer 100 according to this embodiment, the detection conditions for specifying the ranges of the number, sizes and positions of the organ areas to be detected upon detection of the organ areas in the face area are set on the basis of the detection result of the face area and the organ areas satisfying the set detection conditions are detected. That is, only the organ areas satisfying the detection conditions are detected. When an image area which can be determined as an organ area by the evaluation does not satisfy the detection conditions, the image area is not detected as the organ area. Accordingly, in the face area and organ area detecting process of the printer 100 according to this embodiment, the accuracy of the process of detecting an organ area in an image is improved and the efficiency of the detecting process is increased.

### B. Second Embodiment

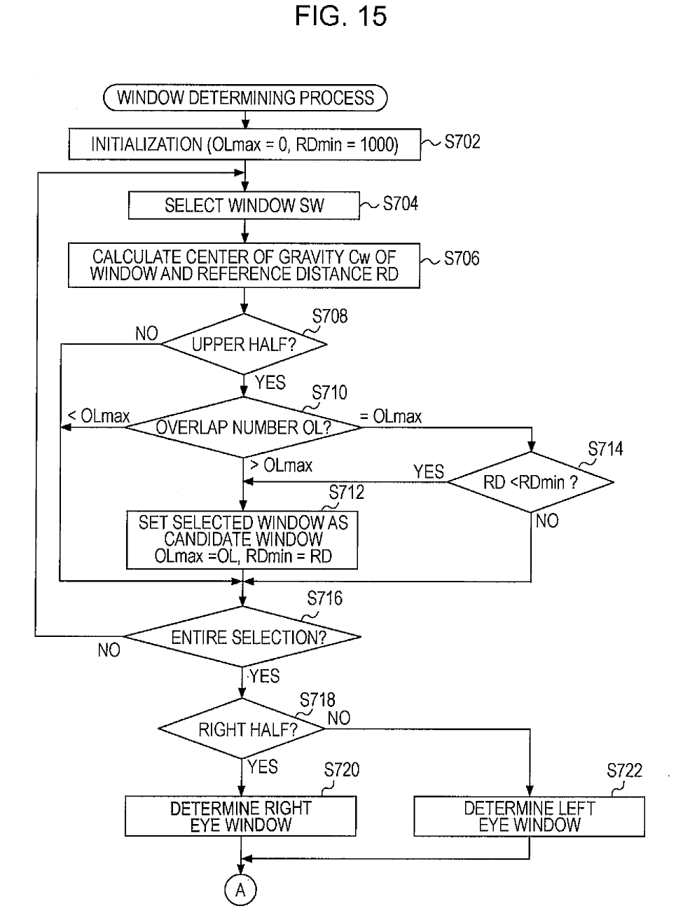

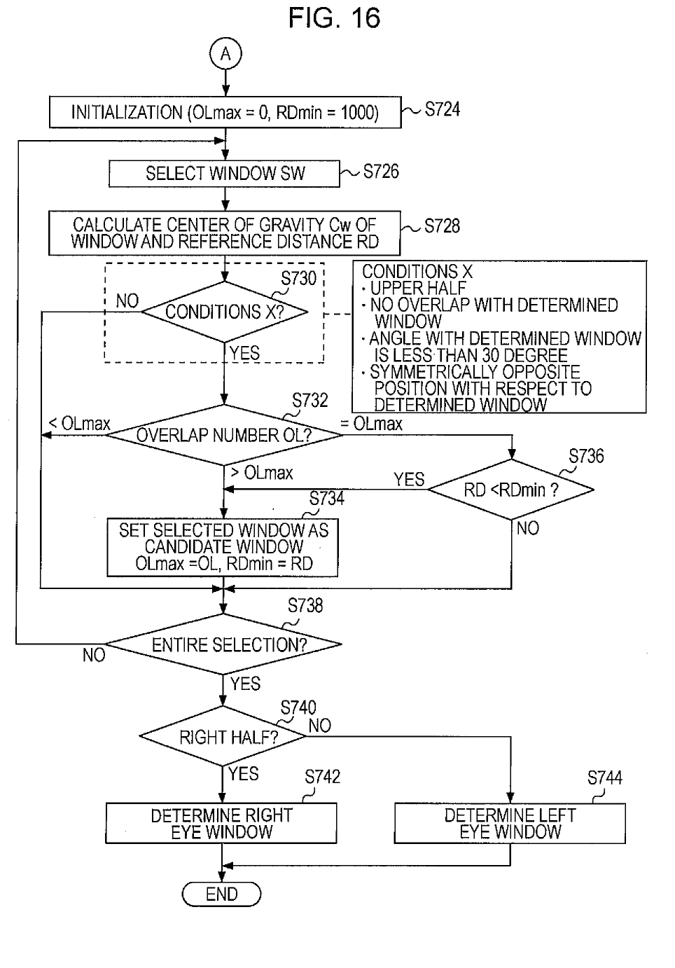

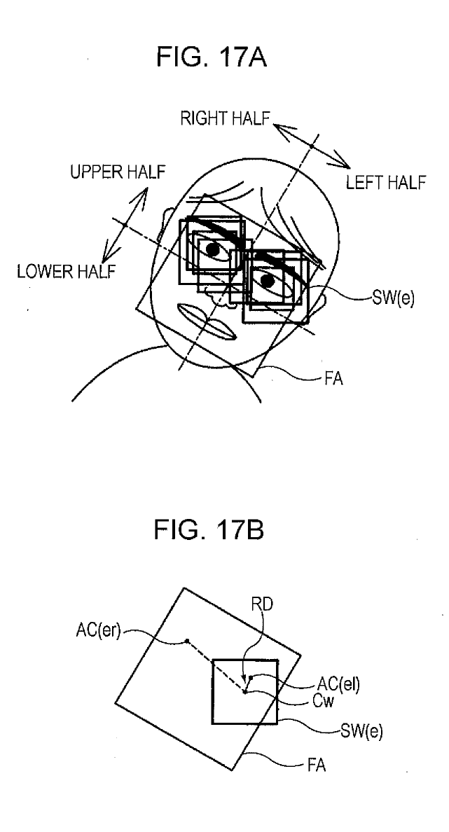

FIGS. 15 and 16 are flowcharts of a window determining process according to a second embodiment of the invention. FIGS. 17A and 17B are diagrams illustrating the window determining process according to the second embodiment of the invention. The window determining process according to the second embodiment is a part of the organ area determining process (Step S620) in the organ area detecting process (FIG. 12) according to the first embodiment. Specifically, the window determining process determines the windows SW (the right eye window SW(er) and the left eye window SW(el), see FIGS. 14A and 14B) corresponding to the right eye area EA(r) and the left eye area EA(l) when the coordinates of the plurality of windows SW are stored for the eye area EA in Step S570 of FIG. 12.

In Step S702 (FIG. 15), the area setting unit 214 performs initialization. Specifically, a value of the maximum value OLmax of a window overlap number OL is set to 0 and a value of the minimum value RDmin of a reference distance RD is set to 1,000. In initialization, the value of the minimum value RDmin of the reference distance may be set to a relatively large value, so the reference distance RD to be calculated later may not exceed the value of the minimum value RDmin. The value of the minimum value RDmin may not be set to 1,000.

In Step S704, the area setting unit 214 selects one window SW (represented by the window SW(e)) corresponding to the eye area EA. The window SW(e) corresponding to the eye area EA is a window SW determined as an image area corresponding to an eye image by organ determination using the facial organ learning data OLD corresponding to an eye. In FIG. 17A, a plurality of windows SW(e) are shown and one of the plurality of windows SW(e) is selected.

In Step S706, the area setting unit 214 calculates coordinates of a center of gravity CW and a reference distance RD of the selected window SW(e). As illustrated in FIG. 17B, in this embodiment, in a face area FA, a standard center of gravity AC(er) that is a standard position of the center of gravity of a right eye area EA(r) and a standard center of gravity AC(el) that is a standard position of the center of gravity of a left eye area EA(l) are set in advance. The reference distance RD is a smaller one of distances between the center of gravity Cw of the selected window SW(e) and the standard center of gravity AC(er) and the standard center of gravity AC(el).

In Step S708, the area setting unit 214 determines whether the center of gravity Cw of the selected window SW(e) is positioned in an upper portion of the face area FA. As illustrated in FIG. 17A, the upper portion of the face area FA is an area corresponding to an upper portion of a face when the rectangular face area FA is divided into halves with a straight line parallel to the outer circumferential line of the face area FA corresponding to a horizontal direction of the face. Similarly, an-area corresponding to a lower portion of the face when the face area FA is divided into halves with the straight line parallel to the outer circumferential line of the face area FA corresponding to the horizontal direction of the face is referred to as the lower portion of the face area FA. In addition, an area corresponding to a right portion of the face when the face area FA is divided into halves with a straight line parallel to the outer circumferential line of the face area FA corresponding to a vertical direction of the face is referred to as the right portion of the face area FA, and an area corresponding to the remaining portion is referred to as the left portion of the face area FA. When it is determined that the center of gravity Cw of the selected window SW(e) is not positioned in the upper portion of the face area FA, it is determined that the selected window SW(e) is not the window SW corresponding to the eye area EA and thus Steps S710-S714 are skipped. In this case, in Step S716, it is determined whether all the windows SW(e) corresponding to the eye area EA are selected. When there is a window SW(e) that has not been selected yet, the process returns to Step S704 to select the window SW(e).

In Step S708, when it is determined that the center of gravity Cw of the selected window SW(e) is positioned in the upper portion of the face area FA, the area setting unit 214 compares the window overlap number OL with the maximum value OLmax (Step S710). The window overlap number OL is the number of other windows SW(e) at least partially overlapping the selected window SW(e). When the window overlap number OL is larger than the maximum value OLmax in Step S710, or when the window overlap number OL is equal to the maximum value OLmax in Step S710 and the reference distance RD is smaller than the minimum value RDmin in Step S714, the area setting unit 214 sets as a candidate window the window SW(e) that is currently selected (Step S712). At this time, the area setting unit 214 updates the maximum value OLmax as the current window overlap number OL and updates the minimum value RDmin as the current reference distance RD, On the other hand, when the window overlap number OL is smaller than the maximum value OLmax in Step S710, or when the reference distance RD is smaller than the minimum value RDmin in Step S714, Step S712 is skipped and the process proceeds to Step S716.

Steps S704-S714 are repeatedly performed until it is determined that all windows SW(e) corresponding to the eye area EA are selected in Step S716 in this manner, the window SW(e) with the maximum window overlap number OL (the window SW(e) with the minimum reference distance RD when there are plural windows SW(e) with the maximum window overlap number OL) is set as a final candidate window among the windows SW(e) corresponding to the eye area EA.

In Step S718, the area setting unit 214 determines whether the center of gravity Cw of the final candidate window is positioned in the right or left portion of the face area FA. When the center of gravity Cw is positioned in the right portion, the candidate window is determined as the right eye window SW(er) (Step S720) on the other hand, when the center of gravity Cw is positioned in the left portion, the candidate window is determined as the left eye window SW(el) (Step S722).

By the process up to Step S722, one of the-right eye window SW(er) and the left eye window SW(el) is determined. In the subsequent processes (the processes after Step S724 of FIG. 16), the determination of a window SW that has not been determined yet as the right eye window SW(er) and the left eye window SW(el) is performed.

The contents of Steps S724, S726 and S728 of FIG. 16 are the same as the contents of Steps S702, S704 and S706 of FIG. 15. In Step S730 (FIG. 16), the area setting unit 214 determines whether the selected window SW(e) satisfies conditions X. The conditions X include 4 AND conditions, that is, a condition in which the center of gravity Cw of the selected window SW(e) is positioned in the upper portion of the face area FA, a condition in which the selected window SW(e) does not overlap the right eye window SW(er) or the left eye window SW(el) (hereinafter, also referred to as “determined window”) that is determined in Step S720 or S722 of FIG. 15, a condition in which an angle between the selected window SW(e) and the determined window is smaller than 30 degrees, and a condition in which the position of the center of gravity Cw of the selected window SW(e) in the face area FA is bilaterally symmetric with respect to the position of the center of gravity Cw of the determined window. The angle between the selected window SW(e) and the determined window, that is smaller than 30 degrees, is an angle between a straight line connecting the center of gravity Cw of the selected window SW(e) and the center of gravity Cw of the determined window and the outer circumferential line corresponding to the longitudinal direction of the face of the face area FA. When the center of gravity Cw of the selected window SW(e) is not positioned in the upper portion of the face area FA, when the selected window SW(e) even partially overlaps the determined window, when the angle between the selected window SW(e) and the determined window is larger than 30 degrees, and when the position of the center of gravity Cw of the selected window SW(e) in the face area FA is not bilaterally symmetric with respect to the position of the center of gravity Cw of the determined window, it is thought that the window SW(e) does not really correspond to the eye image. Accordingly, when the conditions X are not satisfied, Steps S732-S736 are skipped and the process proceeds to Step S738. Among the four conditions X, the conditions other than the condition in which the center of gravity Cw of the window SW(e) is positioned in the upper portion of the face area FA are associated with geometric relationships between the plurality of windows SW(e) as candidates of the eye area EA.

When the conditions X are satisfied, Steps S732-S736 are performed. The contents of Steps S732-S736 are the same as the contents of Steps S710-S714 of FIG. 15. Steps S726 to S736 are repeatedly performed until it is determined that all the windows SW(e) corresponding to the eye area EA are selected in S738. In this manner, the window SW(e) with the maximum window overlap number OL, satisfying the conditions X, (the window SW(e) with the minimum reference distance RD when there are plural windows SW(e) with the maximum window overlap number OL) is set as a final candidate window among the windows SW(e) corresponding to the eye area EA.

In Step S740 (FIG. 16), the area setting unit 214 determines whether the center of gravity Cw of the final candidate window is positioned in the right or left portion of the face area FA. When the center of gravity Cw is positioned in the right portion, the candidate window is determined as the right eye window SW(er) (Step S742). On the other hand, when the center of gravity Cw is positioned in the left portion, the candidate window is determined as the left eye window SW(el) (Step S744).

In the case of the eye area EA, by the above-described window determining process, the right eye window SW(er) and the left eye window Sw(el) respectively corresponding to the right eye area EA(r) and the left eye area EA(l) are determined when the coordinates of the plurality of windows SW are stored in Step S570 of FIG. 12. In the window determining process according to the second embodiment, the right eye window SW(er) and the left eye window SW(el) are determined on the basis of the conditions associated with the geometric relationships between the plurality of windows SW(e) as candidates of the eye area EA. Accordingly, the accuracy of the process of detecting an organ area in an image can be improved and the efficiency of the detecting process can be increased.

### C. Modified Examples

The invention is not limited to the above-described embodiments, and various modifications and changes can be made without departing from the scope and spirit of the invention. For example, the following modifications can be made.

### C1. First Modified Example

In the above embodiments, detection conditions for specifying ranges of the number, sizes and positions of the organ areas to be detected are set. However, the set detection conditions do not necessarily specify ranges of the number, sizes and positions of the organ areas and may specify a range of at least one of the number, sizes and positions of the organ areas. Even in this case, the accuracy of the process of detecting an organ area in an image is improved and the efficiency of the detecting process is increased.

### C2. Second Modified Example

In the above embodiments, in the organ area detecting process (FIG. 12), the position and size of the window SW are set to satisfy the set detection conditions, and in this manner, the determination target image area JIA is set. However, the determination target image area JIA may be set independently from the detection conditions. In this case, it is determined whether the window SW or the organ area satisfies the set detection conditions after the organ determination (Step S560 of FIG. 12) or the organ area determining process (Step S620 of FIG. 12). Even in this case, the accuracy of the process of detecting an organ area in an image is improved and the efficiency of the detecting process is increased.

### C3. Third Modified Example

In the above embodiments, the detection conditions associated with the position and size of the organ area are set in advance on the basis of the position and size of the facial organ image in the face sample image used for the setting of the face organ learning data OLD. However, statistics of the position and size of the organ image may be collected in the face area detecting process to set the detection conditions on the basis of the statistics.

### C4. Fourth Modified Example

In the second embodiment, the window determining process for the determination of the right eye window SW(er) and the left eye window SW(el) is described. However, the window determining process can be changed into a process of determining a window SW corresponding to another facial organ image. For example, the window determining process may determine the right eye window SW(er), the left eye window SW(el) and the window SW corresponding to a mouth image (mouth window SW(m), see FIGS. 14A and 14B). In this case, the determination of the window SW may be performed using the conditions associated with the geometric relationship between the plural windows SW(e) as candidates of the eye area EA and the mouth area MA.

The window determining process may be performed using reliability of the windows SW(e) as candidates of the eye area EA and the mouth area MA. The reliability is an index for showing a certainty that the windows SW(e) as candidates of the eye area EA and the mouth area MA are image areas really corresponding to the eye area EA and the mouth area MA. As the reliability, the number of windows overlapping the window SW(e) or the cumulative evaluated value Tv calculated for the window SW(e) can be used. Among the windows SW(e) as candidates of the eye area EA and the mouth area MA, the windows SW(e) with high reliability may be determined as the right eye window SW(er), the left eye window SW(el) and the mouth window SW(m). In addition, among the windows SW(e) as candidates of the eye area EA, a combination of the windows SW(e) with high reliability for a combination of two windows SW(e) may be determined as the right eye window SW(er) and the left eye window SW(el). Moreover, among the windows SW(e) as candidates of the eye area EA and the mouth area MA, a combination of the windows SW(e) with the high sum of reliability of a combination of two windows SW(e) as the eye area and reliability of one window SW(e) as the mouth area may be determined as the right eye window SW(er), the left eye window SW(el) and the mouth window SW(m).

### C5. Fifth Modified Example

The face area detecting process (FIG. 4) and the organ area detecting process (FIG. 12) according to the above-described embodiments are illustrative only, and various modifications thereof can be made. For example, the size of the face detecting image FDImg (see FIG. 5) is not limited to horizontal 320 pixels×vertical 240 pixels, and the face detecting image FDImg may have other sizes. The original image OImg may be used as the face detecting image FDImg. In addition, the size, movement direction and movement amount (movement pitch) of the window SW used are not limited to the above. In the above-described embodiments, the size of the face detecting image FDImg is fixed and a window SW having one of a plurality of sizes is arranged on the face detecting image FDImg to set the determination target image area JIA having one of a plurality of sizes. However, face detecting images FDImg having a plurality of sizes may be generated, and a window SW having a fixed size may be arranged on the face detecting image FDImg to set the determination target image area JIA having one of a plurality of sizes.

In the above-described embodiments, the cumulative evaluated value Tv is compared with the threshold value TH to perform face determination and organ determination (see FIG. 6). However, other methods including a method of using a plurality of determining units to perform face determination and organ determination may be used. A learning method used to set the face learning data FLD and the facial organ learning data OLD may vary depending on the face and organ determining method. A learning method is not necessarily used to perform face and organ determination, and other methods, such as pattern matching, may be used to perform face and organ determination.

In the above-described embodiments, 12 specific face inclinations are set at an angular interval of 30 degrees. However, specific face inclinations more or less than 12 specific face inclinations may be set. In addition, the specific face inclination is not necessarily set, but the face determination may be performed for a face inclination of 0 degrees. In the above-described embodiments, the face sample image group includes images obtained by enlarging, reducing, and rotating the basic face sample image FIo, but the face sample image group does not necessarily include the images.

In the above-described embodiments, when it is determined that the determination target image area JIA defined by the window SW having a certain size is an image area corresponding to a face image (or a facial organ image) by the face determination (or the organ determination), a window SW having a size that is reduced from the size at a predetermined ratio or more may be arranged out of the determination target image area JIA that is determined as the image area corresponding to the face image. In this manner, it is possible to improve process speed.

In the above-described embodiments, the image data stored in the memory card MC is set as the original image data, but the original image data is not limited to the image data stored in the memory card MC. For example, the original image data may be image data acquired through a network.

In the above-described embodiments, the right eye, the left eye, and the mouth are set as the kinds of facial organs, and the right eye area EA(r), the left eye area EA(l), and the mouth area MA are detected as the organ areas. However, any organ of the face may be set as the kind of facial organ. For example, one or two of the right eye, left eye, and mouth may be set as the kind of facial organ. In addition, other organs (for example, a nose or an eyebrow) in the face may be set as the kind of facial organ, in addition to the right eye, left eye, and mouth, or instead of at least one of the right eye, left eye, and mouth, and areas corresponding to the images of the organs may be selected as the organ areas.

In the above-described embodiments, the face area FA and the organ area have rectangular shapes, but the face area FA and the organ area may have shapes other than a rectangle.

In the above-described embodiments, image processing performed by the printer 100, serving as an image processing apparatus, is described. However, a portion or the entire image processing may be performed by other types of image processing apparatuses, such as a personal computer, a digital still camera, and a digital video camera. In addition, the printer 100 is not limited to an ink jet printer, and other types of printers, such as a laser printer and a dye sublimation printer, may be used.

In the above-described embodiments, some components implemented by hardware may be substituted for software, and some components implemented by software may be substituted for hardware.

When some or all of the functions of the invention are implemented by software, the software (computer program) may be stored in a computer readable recording medium and then provided. In the invention, a “computer readable recording medium” is not limited to a portable recording medium, such as a flexible disk or a CD-ROM, and include various internal storage devices provided in a computer, such as a RAM and a ROM, and external storage devices fixed to the computer, such as a hard disk.

What is claimed is:

1. An image processing apparatus comprising:
a face area detecting unit that detects a face area corresponding to a face image in a target image;
a detection condition setting unit that sets a detection condition for specifying a range of at least one of the number, sizes and positions of organ areas to be detected upon detection of the organ area corresponding to a facial organ image in the face area on the basis of a detection result of the face area; and
an organ area detecting unit that detects the organ area satisfying the set detection condition.

2. The image processing apparatus according to claim 1, wherein
the face area detecting unit evaluates a certainty that an image area on the target image is an image area corresponding to a face image by using face evaluating data generated using a sample image including the face image to detect the face area, and
the detection condition setting unit sets the detection condition on the basis of a relationship associated with at least one of the number, sizes and positions between the face area and the organ areas, which is set in advance on the basis of facial organ images in the sample image used for generation of the face evaluating data.

3. The image processing apparatus according to claim 2,
wherein the face evaluating data is associated with a face direction that is a rotation angle about an axis that is parallel to an image plane of a face image in the sample image used for generation of the face evaluating data,
the relationship between the face area and the organ areas is set for each face direction associated with the face evaluating data, and
the detection condition setting unit sets the detection condition on the basis of the relationship corresponding to the face direction associated with the face evaluating data used for the detection of the face area.

4. The image processing apparatus according to claim 2, wherein the organ area detecting unit includes:
a determination target setting unit that sets a determination target image area that is an image area in the face area,
a storing unit that stores organ evaluating data for calculating an evaluated value representing a certainty that the determination target image area is an image area corresponding to a facial organ image,
an evaluated value calculating unit that calculates the evaluated value on the basis of the organ evaluating data and image data corresponding to the determination target image area, and
an area setting unit that sets the organ area on the basis of the evaluated value and the size and position of the determination target image area, and
wherein the determination target setting unit determines at least one of the number, sizes and positions of the determination target image areas to be set on the basis of the relationship between the face area and the organ areas.

5. The image processing apparatus according to claim 2, wherein the face evaluating data is generated by learning using the sample image.

6. The image processing apparatus according to claim 1, wherein the detection condition setting unit sets the detection condition depending on the kind of a facial organ corresponding to the organ area to be detected.

7. The image processing apparatus according to claim 1, wherein the organ area detecting unit detects a plurality of candidates of the organ area to determine the organ area on the basis of geometric relationships between the plurality of candidates of the organ area.

8. The image processing apparatus according to claim 1, wherein the facial organ is at least one of a right eye, a left eye and a mouth.

9. An image processing method comprising:
detecting a face area corresponding to a face image in a target image;
setting a detection condition for specifying a range of at least one of the number, sizes and positions of organ areas to be detected upon detection of the organ area corresponding to a facial organ image in the face area on the basis of a detection result of the face area; and
detecting the organ area satisfying the set detection condition.

10. A computer program for an image process embodied in a computer-readable medium and causing a computer to execute:
a face area detecting function that detects a face area corresponding to a face image in a target image;
a detection condition setting function that sets a detection condition for specifying a range of at least one of the number, sizes and positions of organ areas to be detected upon detection of the organ area corresponding to a facial organ image in the face area on the basis of a detection result of the face area; and
an organ area detecting function that detects the organ area satisfying the set detection condition.
